(19) United States
(12) Patent Application Publication
(10) Pub. No.: US 2018/0228103 A1
(43) Pub. Date: Aug. 16, 2018

(54) CULTIVATION DEVICE

(71) Applicant: Chunghwa Picture Tubes, LTD., Taoyuan City (TW)

(72) Inventors: Shih-Wei Su, Taoyuan City (TW); Ru-Yi Hsieh, Taoyuan City (TW); Chou-Chiang Kuo, New Taipei City (TW)

(73) Assignee: Chunghwa Picture Tubes, LTD., Taoyuan City (TW)

(21) Appl. No.: 15/480,838

(22) Filed: Apr. 6, 2017

(30) Foreign Application Priority Data
Feb. 15, 2017 (CN) 201710080759.9

(51) Int. Cl. A01G 31/02; A01G 17/02; A01G 7/04; A01G 31/06

(52) U.S. Cl. CPC A01G 31/02; A01G 31/06; A01G 7/045; A01G 17/02

(57) ABSTRACT

Provided is a cultivation device, including a planting trough, a first auxiliary member and a second auxiliary member. A plant is cultivated in the planting trough. The first auxiliary member and the second auxiliary member are fixed on the planting trough and tilt toward an outside of the planting trough, and here the first auxiliary member and the second auxiliary member are opposite in tilting direction. The plant grows from the planting trough along the first auxiliary member and the second auxiliary member. The cultivation device provided in this invention may utilize space effectively for the plant to grow and is conducive to mechanical harvesting and/or hand harvesting.

### CROSS-REFERENCE TO RELATED APPLICATION

This application claims the priority benefit of China application serial no. 201710080759.9, filed on Feb. 15, 2017. The entirety of the above-mentioned patent application is hereby incorporated by reference herein and made a part of this specification.

### BACKGROUND OF THE INVENTION

### Field of the Invention

The invention relates to a cultivation device and particularly relates to a cultivation device for cultivating plants.

### Description of Related Art

Traditional agriculture uses open farmlands to cultivate plants. As a result, it is not only necessary to obtain a vast area of land, but traditional agriculture is susceptible to impacts of weather and foreign species, thus leading to instability of production. In hydroponic culture, soil is not required to cultivate plants whereas nutrients needed for the growth of plants are primarily carried by water. Since hydroponic culture does not require the use of soil, it can reduce the large cost due to the purchase of vast land in the case of traditional agriculture. Besides, hydroponic devices in hydroponic culture can be set in a greenhouse so as to be exempt from the impacts of weather and foreign species. Therefore, in recent years hydroponic culture has become immensely popular. However, hydroponic culture currently is dominated by leaf vegetable. There is not yet a hydroponic design suitable for fruit plants.

### SUMMARY OF THE INVENTION

The invention provides a cultivation device that is particularly suitable for hydroponic culture of fruit plants.

The cultivation device of the invention includes a planting trough, a first auxiliary member and a second auxiliary member. A plant is cultivated in the planting trough. The first auxiliary member and the second auxiliary member are fixed on the planting trough and tilt toward an outside of the planting trough. The first auxiliary member and the second auxiliary member are opposite in tilting direction. The plant grows from the planting trough along the first auxiliary member and the second auxiliary member.

In the cultivation device according to an embodiment of the invention, the cultivation device may further include a first fixing member and a second fixing member. The first fixing member is fixed on the planting trough. The second fixing member is disposed opposite the planting trough. Two ends of the first auxiliary member are fixed on the first fixing member and the second fixing member respectively. Two ends of the second auxiliary member are fixed on the first fixing member and the second fixing member respectively.

In the cultivation device according to an embodiment of the invention, the cultivation device may further include a circulating pipeline. At least part of the circulating pipeline is fixed on the planting trough, and a nutrient solution is transmitted to a root of the plant via the circulating pipeline. The first fixing member may include at least part of the circulating pipeline.

In the cultivation device according to an embodiment of the invention, the planting trough may include a bottom and a sidewall. The bottom is disposed opposite the first auxiliary member and the second auxiliary member, the sidewall is connected to the bottom, and the first fixing member is fixed on the sidewall of the planting trough.

In the cultivation device according to an embodiment of the invention, the cultivation device may further include a planting rack. At least part of the planting rack is positioned above the planting trough, and the second fixing member includes at least part of the planting rack.

In the cultivation device according to an embodiment of the invention, the planting rack is in a frame shape and the planting trough is disposed inside the planting rack that is in the frame shape.

In the cultivation device according to an embodiment of the invention, the cultivation device may further include a light source that emits light on the plant.

In the cultivation device according to an embodiment of the invention, the cultivation device may further include a lifting system. The lifting system is connected to the light source and makes a distance between the light source and the planting trough become adjustable.

In the cultivation device according to an embodiment of the invention, the lifting system may include at least one pulley, a rope and a motor. The rope is disposed on the pulley. The motor drives the rope so as to adjust the distance between the light source and the planting trough.

In the cultivation device according to an embodiment of the invention, the planting trough is for accommodating a nutrient solution, and the cultivation device may further include a top cover. The top cover is disposed on the planting trough so as to shelter the nutrient solution in the planting trough, and the planting trough and the top cover are lightproof.

In the cultivation device according to an embodiment of the invention, the cultivation device may further include a top cover and a circulating pipeline. The top cover shelters an opening of the planting trough and has a plurality of first through holes. The circulating pipeline has a plurality of branch portions. The branch portions are inserted into the first through holes of the top cover respectively so as to extend into the opening of the planting trough.

Based on the above, in the cultivation device according to an embodiment of the invention, the first auxiliary member and the second auxiliary member are fixed on the planting trough and tilt toward an outside of the planting trough. The first auxiliary member and the second auxiliary member are opposite in tilting direction, and the plant grows from the planting trough along the first auxiliary member and the second auxiliary member. Through the first auxiliary member and the second auxiliary member, the cultivation device may utilize space effectively for the plant to grow. Besides, since the first auxiliary member and the second auxiliary member tilt toward the outside of the planting trough and are opposite in tilting direction, after the plant grows up and bears a fruit, the fruit would suspend toward the outside of the planting trough, thereby conducive to mechanical harvesting or hand harvesting.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A illustrates a schematic cross-sectional view of a cultivation device according to an embodiment of the invention.

FIG. 1B illustrates a schematic cross-sectional view of the planting trough, the top cover and the circulating pipeline of FIG. 1A.

FIG. 2 illustrates a schematic view of a light source and a lifting system of the cultivation device according to an embodiment of the invention.

### DESCRIPTION OF THE EMBODIMENTS

In the following, some of the exemplary embodiments of the invention are described in detail with reference to the accompanying drawings. Whenever possible, the same reference numerals used in the accompanying drawings and the below description are viewed as indicating identical or similar components.

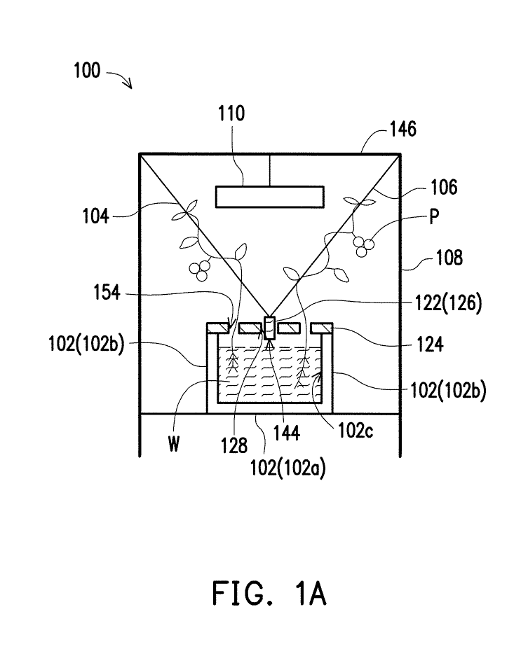

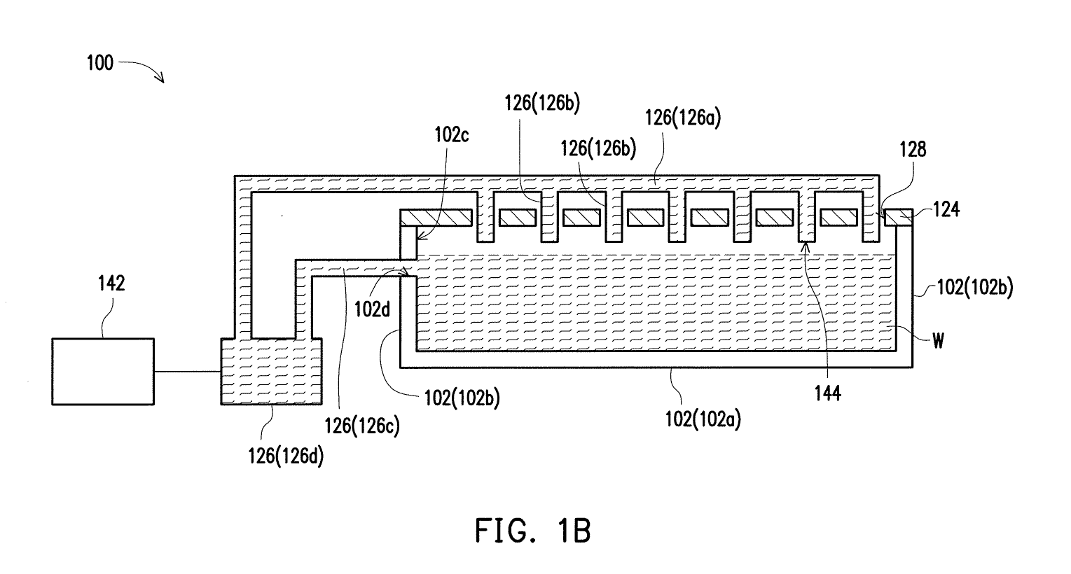

FIG. 1A illustrates a schematic cross-sectional view of a cultivation device according to an embodiment of the invention. FIG. 1B illustrates a schematic cross-sectional view of the planting trough 102, the top cover 124 and the circulating pipeline 126 of FIG. 1A. With reference to FIG. 1A and FIG. 1B simultaneously, a cultivation device 100 for cultivating a plant P includes a planting trough 102, a first auxiliary member 104 and a second auxiliary member 106. The plant P is cultivated in the planting trough 102 and is suitable for growing along the first auxiliary member 104 and the second auxiliary member 106. The cultivated plant P includes but is not limited to a fruit plant. The fruit plant is, for example, a tomato, but the invention is not limited thereto. The planting trough 102 may include a bottom 102a and a sidewall 102b. The bottom 102a is disposed opposite the first auxiliary member 104 and the second auxiliary member 106, the sidewall 102b is connected to the bottom 102a, and the bottom 120a and the sidewall 102b define an opening 102c of the planting trough 102. The opening 102c of the planting trough 102 is for accommodating a nutrient solution W, which contains necessary nutrients for the plant P to grow.

The first auxiliary member 104 and the second auxiliary member 106 are fixed on the planting trough 102 and tilt toward an outside of the planting trough 102, and here the first auxiliary member 104 and the second auxiliary member 106 are opposite in tilting direction. The first auxiliary member 104 and the second auxiliary member 106 may be symmetrical or asymmetrical to each other. In this embodiment, the first auxiliary member 104 and the second auxiliary member 106 are, for example, ropes, but the invention is not limited thereto. Any component suitable for guiding the plant P to grow may be used as the first auxiliary member 104 and the second auxiliary member 106. The plant P may grow from the planting trough 102 along the first auxiliary member 104 and the second auxiliary member 106. Specifically, during the growing process of the plant P, vines of the plant P may climb upwards and outwards along the first auxiliary member 104 and the second auxiliary member 106. When the plant P bears a fruit, the fruit would naturally suspend toward the outside of the planting trough 102 due to an effect of gravity, thereby conducive to mechanical harvesting or hand harvesting.

In an embodiment of the invention, the cultivation device 100 further includes a top cover 124 and a circulating pipeline 126. The top cover 124 is disposed on the opening 102c of the planting trough 102 so as to shelter the nutrient solution W in the planting trough 102. To prevent algae from multiplying, the planting trough 102 and the top cover 124 are preferably lightproof, but the invention is not limited thereto. The top cover 124 may have a plurality of first through holes 128 and a plurality of second through holes 154. The second through holes 154 of the top cover 124 are provided for the plant P to pass through. The circulating pipeline 126 includes a first connecting portion 126a, a plurality of branch portions 126b, a second connecting portion 126c, and a water storage tank 126d. The first connecting portion 126a connects to and communicates with the branch portions 126b. The branch portions 126b are inserted into the first through holes 128 of the top cover 124 respectively so as to extend into the opening 102c of the planting trough 102. The first connecting portion 126a and the branch portions 126b of the circulating pipeline 126 are fixed on the planting trough 102. The nutrient solution W may be transmitted to a root of the plant P via the circulating pipeline 126. Because water outlets 144 of the branch portions 126b are located above the fluid level of the nutrient solution W, dissolved oxygen in the nutrient solution W may be increased during the process when the nutrient solution W is infused into the planting trough 102. In addition, the first connecting portion 126a is connected to the water storage tank 126d, and the second connecting portion 126c is for connecting the water storage tank 126d and the planting trough 102, so that the nutrient solution W in the planting trough 102 may flow to the water storage tank 126d through the second connecting portion 126c. For example, a through hole 102d may be provided on the sidewall 102b of the planting trough 102 so that the nutrient solution W in the planting trough 102 may be discharged into the water storage tank 126d by the way of overflow. The nutrient solution W in the water storage tank 126d may then be transmitted to the first connecting portion 126a and the branch portions 126b via a pump 142 so as to water the root of the plant P again. In this way, the nutrient solution W may enter into the planting trough 102 again through the branch portions 126b so as to continuously irrigate the plant P in a circulating manner.

In an embodiment of the invention, the cultivation device 100 further includes a planting rack 108. At least part of the planting rack 108 is positioned above the planting trough 102. Furthermore, in this embodiment, the planting rack may be in a frame shape, and the planting trough 102 is disposed inside the planting rack 108 that is in the frame shape. But the invention is not limited thereto. In other embodiments, the planting rack 108 may be in other suitable shapes, and the planting trough 102 is not necessarily disposed inside the planting rack 108. For example, in this embodiment, the planting rack 108 may be composed of a plurality of rods to provide a firm support. But the invention is not limited thereto. In other embodiments, the planting rack 108 may also be an integrally formed support rack.

Besides, the cultivation device 100 further includes a first fixing member 122 fixed on the planting trough 102 and a second fixing member 146 disposed opposite the planting trough 102. Two ends of the first auxiliary member 104 are fixed on the first fixing member 122 and the second fixing member 146 respectively. Two ends of the second auxiliary member 106 are fixed on the first fixing member 122 and the second fixing member 146 respectively. For example, in this embodiment, the first fixing member 122 includes at least part of the circulating pipeline 126. One end of the first auxiliary member 104 and/or the second auxiliary member 106 may be fixed on at least part of the circulating pipeline 126, such as may be tied on the first connecting portion 126a or tied on an intersection of the branch portion 126b and the first connecting portion 126a. But the invention is not limited thereto. In other embodiments of the invention, the first fixing member 122 may also be fixed on the sidewall 102b of the planting trough 102, and the first fixing member 122 may be a clip or a hook fixed on the sidewall 102b, an aperture of the sidewall 102b, or a combination thereof. In this embodiment, the second fixing member 146 is, for example, at least part of the planting rack 108. For example, the other end of the first auxiliary member 104 or the second auxiliary member 106 may also be directly tied on at least part of the planting rack 108, but the invention is not limited thereto.

In an embodiment of the invention, the cultivation device 100 may include a light source 110. The light source 110 is for emitting light on the plant P. The light source 110 includes but is not limited to a light-emitting diode (LED). The light source 110 may be a device independent of the cultivation device 100 or a device integrated into the cultivation device 100. In this embodiment, the light source 110 may be integrated into the cultivation device 100. More specifically, the light source 110 may face the planting trough 102 and be suspended above the planting rack 108.

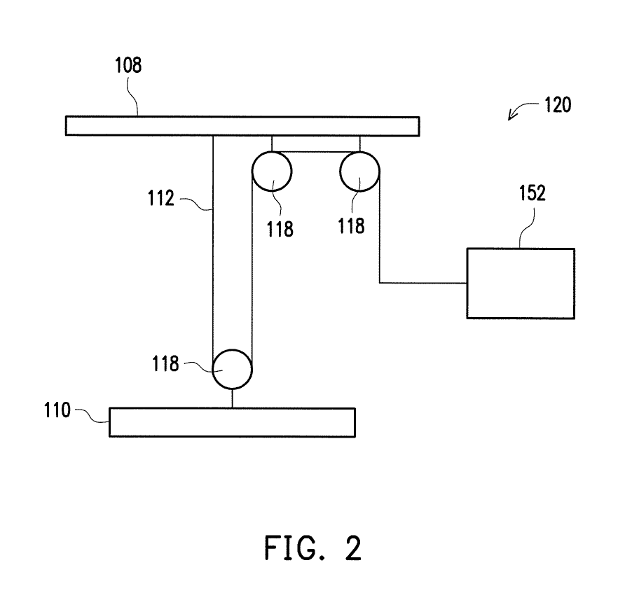

FIG. 2 illustrates a schematic view of a lifting system in the cultivation device according to an embodiment of the invention. With reference to FIG. 1A and FIG. 2, the light source 110 may be connected to a lifting system 120 and make the distance between the light source 110 and the planting trough 102 become adjustable. Specifically, the lifting system 120 includes at least one pulley 118, a rope 112 and a motor 152. The pulley 118 may include a fixed pulley, a moveable pulley or a combination thereof. For example, in the embodiment, the pulley 118 may include two fixed pulleys that are connected to the planting rack 108 and one moveable pulley that is connected to the light source 110. One end of the rope 112 is connected to the motor 152. The rope 112 winds around all of the pulleys 118 and is disposed on all of the pulleys 118. The motor 152 may drive the rope 112 to move along the pulleys 118 so as to lift or lower the moveable pulley and the light source 110, thereby adjusting the distance between the light source 110 and the planting trough 102. But the invention is not limited thereto. Any module or system that allows the light source 110 to move up and down may be used in this invention. By adjusting the distance between the light source 110 and the planting trough 102, an illumination area of the light source 110 may be adjusted to coordinate with the growth of the plant P so as to achieve an energy saving effect. Specifically, the cultivation device 100 has the first auxiliary member 104 and the second auxiliary member 106 that tilt toward an outside of the planting trough 102, and the first auxiliary member 104 and the second auxiliary member 106 are opposite in tilting direction. In the early stage of cultivating the plant P, because the plant P is smaller and has fewer leaves, there is no need for too much space and illumination area. The light source 110 may be lowered to a position close to the planting trough 102 and the luminous power of the light source 110 may also be adjusted to be lower so as to save energy. During the growing process of the plant P, vines of the plant P climb upwards and outwards along the first auxiliary member 104 and the second auxiliary member 106. Even after the plant P grows up, has more leaves and becomes larger in the upper portion, there is still enough room for the plant P to grow. In addition, in coordination with the dense growth of the plant P, the position of the light source 110 may be lifted so as to increase the illumination area. All in all, the light source 110 may be lifted or lowered in coordination with the growth height of the plant P so as to emit light on the plant P with suitable illumination area and luminous power and thus achieve an energy saving effect.

In summary of the above, based on the cultivation device according to the embodiments of the invention, the first auxiliary member and the second auxiliary member are fixed on the planting trough and tilt toward an outside of the planting trough. Here the first auxiliary member and the second auxiliary member are opposite in tilting direction, and the plant grows from the planting trough along the first auxiliary member and the second auxiliary member. As a result, the cultivation device may utilize space effectively for the plant to grow and is conducive to mechanical harvesting or hand harvesting. Besides, an energy saving effect may be achieved by coordinating with the lifting light source.

Although the embodiments are already disclosed as above, these embodiments should not be construed as limitations on the scope of the invention. It will be apparent to those ordinarily skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. A cultivation device, comprising:
a planting trough, in which a plant is cultivated; and
a first auxiliary member and a second auxiliary member that are fixed on the planting trough and tilt toward an outside of the planting trough, wherein the first auxiliary member and the second auxiliary member are opposite in tilting direction, and the plant grows from the planting trough along the first auxiliary member and the second auxiliary member.

2. The cultivation device according to claim 1, further comprising:
a first fixing member fixed on the planting trough; and
a second fixing member disposed opposite the planting trough, wherein two ends of the first auxiliary member are fixed on the first fixing member and the second fixing member respectively, and two ends of the second auxiliary member are fixed on the first fixing member and the second fixing member respectively.

3. The cultivation device according to claim 2, further comprising:
a circulating pipeline, wherein at least part of the circulating pipeline is fixed on the planting trough, a nutrient solution is transmitted to a root of the plant via the circulating pipeline, and the first fixing member comprises the at least part of the circulating pipeline.

4. The cultivation device according to claim 2, wherein the planting trough comprises a bottom and a sidewall, the bottom is disposed opposite the first auxiliary member and the second auxiliary member, the sidewall is connected to the bottom, and the first fixing member is fixed on the sidewall of the planting trough.

5. The cultivation device according to claim 2, further comprising:
a planting rack, wherein at least part of the planting rack is positioned above the planting trough, and the second fixing member comprises the at least part of the planting rack.

6. The cultivation device according to claim 5, wherein the planting rack is in a frame shape and the planting trough is disposed inside the planting rack that is in the frame shape.

7. The cultivation device according to claim 1, further comprising:
a light source that emits light on the plant.

8. The cultivation device according to claim 7, further comprising:
a lifting system that is connected to the light source and makes a distance between the light source and the planting trough become adjustable.

9. The cultivation device according to claim 8, wherein the lifting system comprises:
at least one pulley;
a rope disposed on the pulley; and
a motor that drives the rope so as to adjust the distance between the light source and the planting trough.

10. The cultivation device according to claim 1, wherein the planting trough is for accommodating a nutrient solution, the cultivation device further comprising:
a top cover disposed on the planting trough so as to shelter the nutrient solution in the planting trough, wherein the planting trough and the top cover are lightproof.

11. The cultivation device according to claim 1, further comprising:
a top cover that shelters an opening of the planting trough and has a plurality of first through holes; and
a circulating pipeline that has a plurality of branch portions, wherein the plurality of branch portions are inserted into the plurality of first through holes of the top cover respectively so as to extend into the opening of the planting trough.
